(19) United States
(12) Patent Application Publication
(10) Pub. No.: US 2024/0132286 A1
(43) Pub. Date: Apr. 25, 2024

(54) CONTAINER TERMINAL

(71) Applicant: Hans Künz GmbH, Hard (AT)

(72) Inventors: Roman BEER, Dornbirn (AT); Georg KLAPPER, Hard (AT)

(73) Assignee: Hans Künz GmbH, Hard (AT)

(21) Appl. No.: 18/273,379

(22) PCT Filed: Feb. 17, 2022
(86) PCT No.: PCT/EP2022/053871

§ 371 Date: Jul. 19, 2023

(30) Foreign Application Priority Data
Mar. 17, 2021 (AT) A56/2021

(51) Int. Cl. B65G 1/137

(52) U.S. Cl. CPC B65G 1/137

(57) ABSTRACT

A container terminal (1) for handling containers (2), in particular ISO containers, wherein the container terminal has at least one high-rack store (3) and at least one container-depositing surface (4), which is arranged outside the high-rack store, and a plurality of container transport vehicles (5) for transporting the containers, wherein the high-rack store (3) has a plurality of storage levels (6) arranged above one another and, in each storage level (6), a plurality of rack compartments (7) for receiving at least one of the containers (2), wherein each storage level (6) has, between the rack compartments (7), at least one travelway (8) over which the container transport vehicles (5) can travel, and the container terminal (1) has at least one entry and exit arrangement (9) which connects the container-depositing surface (4) to the travelways (8) in the storage levels (6) and over which the container transport vehicles (5) can travel.

### CROSS-REFERENCE TO RELATED APPLICATIONS

This application is a 371 National Phase of PCT/EP2022/053871, filed Feb. 17, 2022, which claims priority from Austrian Patent Application No. A 56/2021, filed Mar. 18, 2021, both of which are incorporated herein by reference as if fully set forth.

### TECHNICAL FIELD

The present invention relates to a container terminal for handling containers, in particular ISO containers, wherein the container terminal has at least one high-rack store and at least one container-depositing surface, which is arranged outside the high-rack store, and a multiplicity of container transport vehicles for transporting the containers, wherein the high-rack store has a plurality of storage levels arranged above one another and, in each storage level, a plurality of rack compartments for receiving at least one of the containers.

### BACKGROUND

In the field of handling goods, the transport of goods in containers has achieved major importance in the last few decades, both internationally and nationally. Containers are transported both on land by railway or trucks and also by ship with inland and high-sea shipping. A major advantage of the use of containers for goods transport is that a container can be loaded at the place of origin with the good to be transported and unloaded again at the place of destination. During transport, recourse can be had to standardized transport means regardless of the type of good transported in the respective container.

Accordingly, large container terminals have been built both in high-sea and river ports and also inland and allow corresponding handling of goods by means of the containers.

A container terminal of the type in question is described in WO 98/35892 A1, for example. In this container terminal, there is provision that the containers are transported by means of trucks to a reloading station and are reloaded from there onto an internal container transport system of the high-rack store. This represents considerable outlay for the storage and retrieval of the containers.

### SUMMARY

It is an object of the invention to improve the effectiveness over the cited prior art when storing containers in the high-rack store and when retrieving containers from the high-rack store.

For this purpose, when proceeding from a container terminal of the type stated at the outset, the invention makes provision that each storage level has, between the rack compartments, at least one travelway over which the container transport vehicles can travel, and the container terminal has at least one entry and exit arrangement which connects the container-depositing surface to the travelways in the storage levels and over which the container transport vehicles can travel.

It is thus a basic idea of the invention to configure the container terminal in such a way that a container to be stored in the high-rack store can be collected by the container transport vehicle on the container-depositing surface and transported up to the rack compartment in the high-rack store that is provided for this container. When retrieving a container from a rack compartment of the high-rack store, the invention also makes it possible that a container transport vehicle transports the container from the rack compartment of the high-rack store to the container-depositing surface and deposits it there. Here, the invention has the advantage that, during this storage and retrieval process, reloading of the container is no longer necessary, as a result of which the operation of the container terminal is made substantially more effective by comparison with the prior art. In other words, during storing, the containers can be transported by the container transport vehicle from the container-depositing surface to the rack compartment and, during retrieval, can be transported from the rack compartment to the container-depositing surface, without it being necessary in the meantime for the container to be transferred between different transport systems. The invention accordingly makes provision that the container transport vehicles can travel from the container-depositing surface to the rack compartment, and vice versa.

Container terminals according to the invention serve for handling containers. They could correspondingly also be referred to as container handling facilities or container transshipment facilities. They can be used for container handling both in river and high-sea ports and also inland regardless of whether the containers are transported to or from the container terminal by ship, by rail or by truck.

In the case of container terminals according to the invention, a multiplicity of container transport vehicles are used. In this connection, a multiplicity is to be understood in the sense of “a plurality”. The smallest number would thus be two container transport vehicles. However, in practice, substantially more container transport vehicles will be used in a container terminal according to the invention.

The container-depositing surface is a surface outside the high-rack store that offers sufficient space that containers, preferably a multiplicity of containers, can be deposited there and nevertheless there is still enough space for the container transport vehicles to be able to travel to different depositing places in order to deposit or collect containers there. The container-depositing surface is generally a planar free surface which is advantageously situated in the immediate surroundings of the high-rack store. The container-depositing surface will often be a type of apron in front of the high-rack store. In port facilities, for example, this apron can be situated in a region between the high-rack store and a dock with the corresponding container loading cranes. In the case of container terminals according to the invention with railway connection, the container-depositing surface can be situated, for example, between the track system and the high-rack store. Of course, container terminals according to the invention can also comprise a plurality of high-rack stores and a plurality of container-depositing surfaces which are spatially separated from one another.

The high-rack store of container terminals according to the invention can be configured both as an outwardly open, framework-like structure and as a building provided with outer walls and/or a roof. It can be produced from steel, from reinforced concrete, from post or panel systems or else from composite materials.

The use of high-rack stores in container terminals according to the invention allows good use of space. In addition, the high-rack stores have the advantage that for each container there is provided a dedicated rack compartment in which a container can be stored or from which it can also be retrieved again without restacking of containers or the like being necessary for this purpose. This is a key advantage of the use of a high-rack store by comparison with the simple stacking of containers onto one another as is entirely also customary in the prior art. Within the high-rack store there is situated in each storage level at least one travelway over which the container transport vehicles can travel and which leads to the rack compartments of this storage level. The travelways in a storage level are preferably a plurality of travelways which are preferably arranged parallel to one another and next to and between which the rack compartments of the respective storage level are arranged. The travelways could also be referred to as carriageways. What is involved here in each case is a path on which a container vehicle can travel. The travelways in the storage levels can be correspondingly designed as closed, road-like surfaces. However, it is also possible for the purpose of material savings to configure the travelways to be as minimalistic as possible such that they are, for example, only wide enough for the wheels of the transport vehicles to be seated thereon.

A further key advantage of container terminals according to the invention is that they are very freely scalable depending on the amount of the containers to be handled per unit time. Container terminals according to the invention can be adapted in their size and capacity in a virtually arbitrary manner to the expected amount of containers to be handled through the number and size of the high-rack store(s) of a container terminal or through the number of the rack compartments per high-rack store and also through the number of the container transport vehicles.

A further advantage of container terminals according to the invention is that, if the number of containers to be handled per unit time changes, said terminals can also be relatively simply adapted in terms of their capacity, for example by adding additional container transport vehicles or removing remaining container transport vehicles from the system or correspondingly adapting the size and number of the high-rack stores or the rack compartments. If the requirements in a container terminal according to the invention change, the latter is thus subsequently able to be readily expanded but also reduced in size.

The containers are containers in which goods can be stored and transported. In the case of container terminals according to the invention, use is preferably made of so-called ISO containers in accordance with ISO standard 668 which are nowadays used as standard in national and international goods handling. These ISO containers are frequently also referred to as shipping containers. Customary sizes are so-called 20-foot, 30-foot, 40-foot and 45-foot containers.

Container terminals according to the invention are particularly well suited for these containers. However, this does not change the fact that container terminals according to the invention can also be realized for other types of containers. For example, these containers can also be containers which are configured differently and dimensioned differently. Partially open, framework-like containers can also be containers which are handled in container terminals according to the invention. The term “container” is thus to be interpreted as being correspondingly broad for the purposes of the invention.

An entry and exit arrangement of a container terminal according to the invention is an arrangement which allows a container transport vehicle with or without container to pass from a travelway in a storage level of the high-rack store to the container-depositing surface, or vice versa. The entry and/or exit arrangement may be, for example, a ramp over which the container transport vehicles can travel. As an alternative, an entry and exit arrangement can also be designed as an elevator for the container transport vehicles. Advantageously, a plurality of such entry and exit arrangements are present in a container terminal according to the invention and can be used simultaneously. As a result, the redundancy in the overall system can also be increased in order to ensure very high overall facility availability.

Advantageous variants of the invention provide that at least some of the rack compartments in the respective storage level are arranged behind one another in a row along the travelway of this storage level. Preferably, the rack compartments in the respective storage level are situated laterally next to the respective travelway. Particularly preferably, rack compartments are arranged on both sides of a respective travelway in the respective storage level. Preferably, there is also provision that at least one of the storage levels has two travelways, and between these travelways and the entry and exit arrangement there is arranged a drive-over platform for the travel of the container transport vehicles from the entry and exit arrangement to the travelways of this storage level and/or for the travel of the container transport vehicles from the travelways of this storage level to the entry and exit arrangement. Here, the travelways are advantageously arranged so as to be spaced apart from one another and to extend parallel to one another in the respective storage level.

In addition to the container terminal per se, the invention also relates to a method for operating a container terminal according to the invention. Here, there is provision that, for storing in one of the rack compartments, the respective container is collected by the container transport vehicle on the container-depositing surface and is moved with the container transport vehicle via the entry and exit arrangement and the respective travelway of the respective storage level to next to the rack compartment and then stored in the rack compartment and/or that, for retrieval from one of the rack compartments, the respective container is collected by the container transport vehicle at the respective rack compartment and is moved with the container transport vehicle via the respective travelway of the respective storage level and the entry and exit arrangement to the container-depositing surface and unloaded from the container transport vehicle there. Advantageously, the container is deposited here by the container transport vehicle on the container-depositing surface. In this connection, there is particularly preferably provision that the respective container is loaded onto the container transport vehicle and unloaded from the container transport vehicle by means of a loading and unloading device of the container transport vehicle.

In preferred embodiments, the container transport vehicles for transporting containers, in particular ISO containers, have wheels and a steering system for rectilinear travel and for travel around curves on an underlying surface. The container transport vehicles are thus advantageously not rail-bound or suchlike vehicles. Rather, the container transport vehicles can travel rectilinearly, rearward and forward and also around curves. They are thus freely steerable. This allows them to travel to any desired location on the container-depositing surface in order to collect or unload or deposit a container there. This free navigability of the container transport vehicles also has the advantage that, when depositing the containers on the container-depositing surface, no positioning setpoints have to be observed either on the part of the container transport vehicles or on the part of other container handling devices, such as, for example, loading cranes or the like. Rather, the containers can be deposited at any desired location on the underlying surface and also be collected again there. This also leads to acceleration of the overall system.

The container transport vehicle travels on its wheels and is freely steerable by means of the steering system. As a rule, the wheels are arranged at least in pairs on wheel axles. Here, a single wheel axle of the container transport vehicle can be steerable by means of the steering system. However, it is also equally conceivable to configure a plurality of or all the wheels and/or wheel axles of the container transport vehicle to be steerable.

Preferably, as already stated above, there is provision that the container transport vehicles are capable of loading and unloading containers themselves, that is to say without external aids, and this being particularly preferably both on the container-depositing surface and in the high-rack store. In this context, there is thus advantageously provision that the container transport vehicles each have a loading and unloading device for loading at least one container onto the container transport vehicle and for unloading the at least one container from the container transport vehicle.

There is preferably provision that the container transport vehicle has a first vehicle part with a first part of the wheels and a second vehicle part with a second part of the wheels and a crossmember, wherein the vehicle parts are preferably connected to one another exclusively by means of the crossmember, and a container receiving space for receiving at least one container is formed below the crossmember and between the vehicle parts. There is particularly preferably provision here that, with respect to a direction of rectilinear travel of the container transport vehicle, the first vehicle part is arranged in front of the container receiving space and the second vehicle part is arranged behind the container receiving space. For loading and unloading the at least one container, the container receiving space is advantageously open toward at least one side, preferably toward both sides. The terms “toward the side” or “laterally” are always to be understood with respect to the direction of rectilinear travel of the container transport vehicle.

There is particularly preferably provision that, with respect to the direction of rectilinear travel, the loading and unloading device of the container transport vehicle is designed for loading at least one container situated laterally next to the container vehicle into the container receiving space and for unloading the container from the container receiving space onto one side next to the container transport vehicle. In other words, there is advantageously provision that the container transport vehicles each have a direction of rectilinear travel and, with respect to the direction of rectilinear travel, the loading and unloading device of the respective container transport vehicle is designed for loading at least one container situated laterally next to the container transport vehicle onto the container transport vehicle and for unloading the at least one container from the container transport vehicle onto one side next to the container transport vehicle. There is particularly preferably provision here that the loading and unloading device allows loading of a container from both sides of the container transport vehicle and correspondingly unloading of the container onto both sides of the container transport vehicle.

In order to support the forces occurring during the loading and unloading operation, there is advantageously provision that the container transport vehicle has at least one extendable and retractable lateral support for laterally supporting the container transport vehicle with respect to the direction of rectilinear travel. The supports can be different types of lateral supports. They can be provided to ensure that the container transport vehicle is supported by them on an underlying surface. Such lateral supports are used in particular when a container on the container-depositing surface of the container terminal is loaded onto the container transport vehicle or is unloaded therefrom. However, for the operation of storing and retrieving containers in or from the rack compartments of the high-rack store, the container transport vehicle can also have such lateral supports by means of which it is laterally supported on corresponding supporting surfaces in the high-rack store. Particularly preferably, the container transport vehicle has both types of lateral supports.

In order to be able to design the individual storage levels in the high-rack store to be as shallow as possible, there is advantageously provision that the container transport vehicles are not built much higher than the containers to be transported. In this context, there is advantageously provision that the distance, measured in the vertical direction, between a lower edge of the crossmember and a planar underlying surface on which the container transport vehicle stands with its wheels is at most 3.30 m, preferably at most 2.90 m. This is also a key difference of preferred embodiments of container transport vehicles over so-called straddle carriers known in the prior art which are built considerably higher in order also to be able to stack a plurality of containers above one another on a depositing surface.

The container transport vehicle is advantageously of elongate design. It thus has, preferably in all operating states of the container transport vehicle, a length which is greater than the width and than the height of the container transport vehicle.

As already explained at the outset, it is nowadays customary when handling containers, in particular also ISO containers, to handle types of different length in one and the same container terminal. In order to ensure this, in principle container transport vehicles of different lengths can be used in the invention. Here, the container receiving space of a container transport vehicle can have a fixed length adapted to a certain container length. In this context, the container terminal would then precisely comprise container transport vehicles of different lengths in order also to be able to store and retrieve containers of different lengths in the high-rack store and from the high-rack store.

However, in order also to be able to transport or store and retrieve containers of different lengths with a single container transport vehicle, in preferred variants the container transport vehicle is designed to be length-adjustable in itself. There is thus advantageously provision that, to adapt the length of the container receiving space to containers of different lengths, the crossmember is designed to be length-adjustable in a direction of longitudinal extent of the crossmember. In these variants, there is thus provision, by changing the length of the crossmember and thus also the distance between the vehicle parts, to be able to adapt the length of the container receiving space to the length of the container to be transported in each case. For this purpose, the crossmember is advantageously designed to be telescopic.

For the sake of completeness, it is pointed out at this juncture that, in the container transport vehicles, the container receiving space and/or the loading and unloading device can each be designed for loading a single container into the container receiving space. However, it is also conceivable to load more than one container, that is to say for example two containers, simultaneously into one container receiving space of an individual container transport vehicle if the length of the container receiving space and the loading and unloading device of the container transport vehicle are correspondingly configured. Particularly preferably, the two or more containers are then stored behind one another in the container receiving space as viewed in the direction of rectilinear travel of the container transport vehicle.

In principle, it is conceivable that the container transport vehicles are driven and steered by persons in a similar manner to standard commercial trucks. However, particularly preferred embodiments of the invention provide a higher degree of automation. In this connection, there is particularly preferably provision that the container transport vehicles are designed to be self-driving.

Self-driving transport vehicles are known per se in the prior art such that, with respect to the self-driving properties of the container transport vehicles, recourse can be had to technologies known per se in the prior art. What are concerned here may be container terminal-internal navigation systems but also GPS systems and the like. It would also be conceivable for example to install RFID technology in the high-rack store and in the container-depositing surface in order to navigate the container transport vehicles with their aid. Recourse can be had here to all the developments which are already known per se in the prior art for self-driving vehicles. Thus, it is entirely customary nowadays to use self-driving vehicles in company-internal storage systems.

Container transport vehicles of container terminals according to the invention can have both internal combustion engines and electric motors for driving them. These can be battery-operated electric motors but, for example, also those which are operated by means of hydrogen and fuel cells. Energy supply via induction loops or the like is also conceivable. Charging stations at which the batteries of the container transport vehicles can be recharged can also be provided at various locations within the container terminal. In the case of internal combustion engines, all fuel forms known per se are conceivable, such as, for example, diesel and gasoline or else gas, such as, for example, natural gas or hydrogen.

In preferred variants, there is provision that both the driving and the loading and unloading of the containers in the container transport vehicles occurs fully automatically. Here, the container transport vehicles can be designed to be wirelessly remote-controllable from a vehicle control center. There can be provision that the data and information processing occurs centrally in the vehicle control center and the container transport vehicles are exclusively remote-controlled. However, it is also equally readily conceivable that at least some of the control and regulating power is shifted into the individual container transport vehicles. Particularly in these variants, there is advantageously provision that the container transport vehicles can communicate wirelessly with one another. A type of swarm intelligence of the container transport vehicles can be built up in order to achieve as a whole the overall object of storing and retrieving the various containers.

With reference to the variant of the self-driving container transport vehicles, it should be pointed out that they can be designed in such a way that the first and the second vehicle part are of structurally identical design. In such container transport vehicles, it can thus be the case that, other than, for example, in a container transport vehicle with a driver's cab, the front and the rear can no longer be distinguished from one another. However, this does not change the fact that there is a direction of rectilinear travel of the container transport vehicle and an arrangement of the vehicle parts in front of and behind the container receiving space.

Returning to the loading and unloading device, preferred variants of the invention provide that the loading and unloading device of the container transport vehicle has at least two container carrying elements which are extendable and retractable laterally, preferably laterally on both sides, with respect to the direction of rectilinear travel and which can be raised and lowered in the vertical direction, wherein the container carrying elements each have at least one gripping element, preferably at least two gripping elements, for fastening the container carrying elements to the container, preferably to corner fittings of the container, and, for loading onto the container transport vehicle, the container fastened by means of the gripping elements can be lifted off the underlying surface by means of the container carrying elements and moved laterally into the container receiving space, and, for unloading from the container transport vehicle, can be moved laterally out of the container receiving space and lowered, or in other words deposited, onto the underlying surface. The underlying surface can be both a ground surface or a terrain surface of the container-depositing surface and the bottom of a rack compartment.

In order to be able to realize the smallest possible curve radii with the container transport vehicle, a specific embodiment provides that the, preferably all the, wheels of the container transport vehicle can be rotated through at least 90° about a respective vertical axis with respect to the direction of rectilinear travel by means of the steering system. This can be used for two things. Firstly, the container transport vehicle can thereby be driven over very small and narrow regions, for example on correspondingly small platforms between the travelways and the entry and exit arrangement of the container terminal. Secondly, however, this specific type of steerability of the container transport vehicle can also be used for the loading and unloading operation of a container. The possibility of steering through at least 90° with respect to the direction of rectilinear travel also makes it possible, during the loading operation, to drive the container transport vehicle first of all next to the container to be loaded and then, with wheels rotated through 90° with respect to the direction of rectilinear travel, to drive over the container still standing on the underlying surface in order then to correspondingly receive it. The same then correspondingly applies to the unloading operation. In any case, there is advantageously provision in such embodiments that the loading and unloading device of the container transport vehicle has at least two container carrying elements which can be raised and lowered in the vertical direction, wherein the container carrying elements each have at least one gripping element, preferably at least two gripping elements, for fastening the container carrying element to the container, preferably to corner fittings of the container.

### BRIEF DESCRIPTION OF THE DRAWINGS

Further features and details of preferred embodiments of the invention will be explained by way of example below from the description of the figures, in which:

FIGS. 1 to 4 show schematic illustrations of various embodiments according to the invention of container terminals;

FIG. 5 shows an enlarged sectional illustration in the region of a travelway of a storage level;

FIG. 6 shows the region Z from FIG. 5 in enlarged form;

FIGS. 7 to 34 show various illustrations of a first exemplary embodiment of a container transport vehicle for container terminals according to the invention;

FIGS. 35 to 37 show illustrations of modified forms of this first exemplary embodiment of the container transport vehicle;

FIGS. 38 to 47 show illustrations of a further version of a container transport vehicle for a container terminal according to the invention, and

FIG. 48 shows a modified form of the exemplary embodiment according to FIGS. 38 to 47.

### DETAILED DESCRIPTION

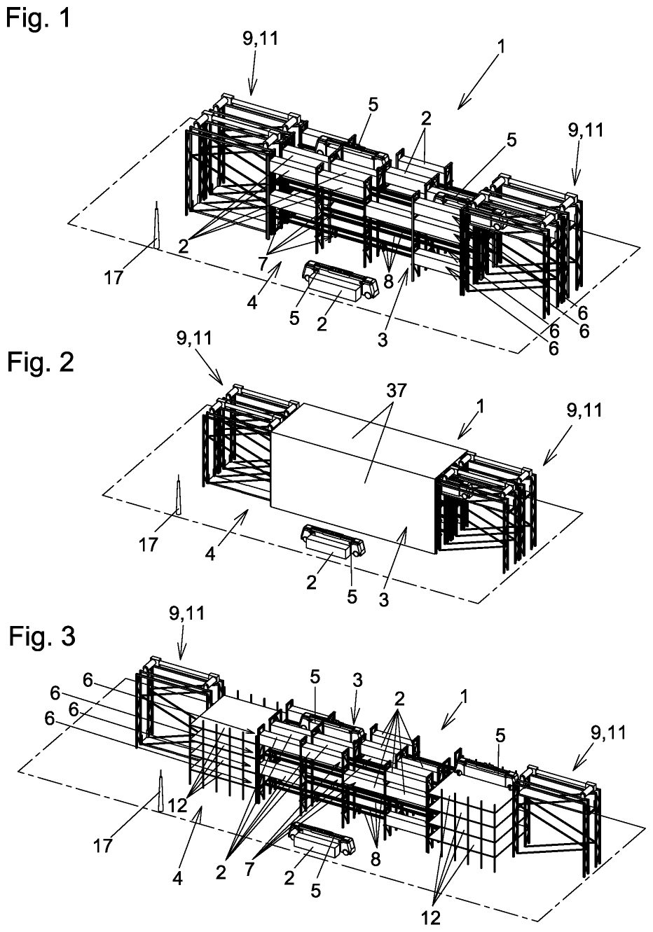

The first variant shown in FIG. 1 of a container terminal 1 according to the invention comprises a high-rack store 3 and a container-depositing surface 4 which is arranged outside the high-rack store 3. This container-depositing surface 4 can, for example, adjoin a berth for a container ship or the track system of a container loading railroad station. The cranes with which the containers 2 can be unloaded from a ship, from the railway wagon or else from trucks and deposited on the container-depositing surface 4 are not illustrated here. However, in this respect, all such technologies known per se in the prior art can be used.

The containers 2 can be so-called ISO containers of different lengths, that is to say, for example, 20-foot, 30-foot, 40-foot and 45-foot containers in accordance with the ISO standard 668. However, as explained at the outset, container terminals 1 according to the invention can also be designed for completely different types of containers 2.

The high-rack store 3 has a plurality of storage levels 6 arranged above one another, 4 four here in this exemplary embodiment. In each storage level 6 there is a multiplicity of rack compartments 7 for receiving at least one of the containers 2 each. Travelways 8 over which the container transport vehicles 5 can travel are arranged in each storage level 6 between the rack compartments 7. The container transport vehicles 5 can travel on these travelways 8 to next to the respective rack compartment 7 in order to store a container 2 there or to remove a container from this rack compartment 7. The travelways 8 in the high-rack store 3 are connected to the container-depositing surface 4 via entry and exit arrangements 9 over which the container transport vehicles 5 can travel. In the first exemplary embodiment according to FIG. 1, the entry and exit arrangements 9 are elevators 11. The container transport vehicles coming from the container-depositing surface 4 can travel into these elevators 11. The respective elevator 11 then transports the respective container transport vehicle 5 to the travelway 8 of that storage level 6 which the container transport vehicle 5 must then travel along in order to reach the respective rack compartment 7. The return travel from the rack compartment 7 to the container-depositing surface 4 then occurs the other way around, likewise again via one of the elevators 11. As also illustrated here, it is expedient for the purpose of optimally efficient and also redundant operation that the high-rack store 3 and its travelways 8 can be reached via a plurality of entry and exit arrangements 9, that is to say elevators 11 in the first exemplary embodiment. As a result, a relatively large number of container transport vehicles 5 can be raised to the respective travelways 8 relatively quickly or lowered from them again to the level of the container-depositing surface 4. Moreover, the container terminal 1 remains operationally ready even if one of the elevators 11 should fail.

As already explained at the outset, the size of the high-rack store or the number of the rack compartments 7 and the number of the container transport vehicles 5 used in this container terminal 1 can be adapted in a relatively freely scalable manner to the amount of containers 2 to be stored and retrieved per unit time. A multiplicity of container transport vehicles 5 can simultaneously collect containers 2 either on the container-depositing surface 4, load them and transport them to the respectively provided rack compartment 7 and store them there or even transport them on the reverse path. In principle, it is conceivable to configure the container transport vehicles 5, for example, with driver's cabs such that they are driven or controlled by persons. However, as already explained at the outset, preferred variants of the invention provide that the container transport vehicles 5 are designed to be self-driving. The control of the storage and retrieval process is then advantageously taken over at least in part by a vehicle control center 17 which is symbolically illustrated here as a simple radio mast. The various possibilities of how in this way the storage and retrieval process of the containers 2 by means of the container transport vehicles 5 can be automated or fully automated have already been discussed further above.

Whereas the variant according to FIG. 1 is an outwardly open high-rack store 3 of framework-like design, FIG. 2 shows a variant in which the high-rack store 3 has an outer envelope 37 consisting of outer walls and a roof. This is intended to illustrate that the high-rack store 3 can of course also be configured as a type of building. Mixed forms, for example only with outer walls or only with a roof, are also conceivable.

FIG. 3 shows a variant of a container terminal 1 according to the invention in which in each case a platform 12 over which the container transport vehicles 5 can travel is formed between the entry and exit arrangement 9, which again is in each case designed as an elevator 11, and the travelways 8. In this exemplary embodiment according to FIG. 3, two platforms 12 which adjoin the travelways 8 of the respective storage level 6 at the end sides are formed here in each storage level 6. These platforms 12 serve to ensure that the container transport vehicles 5 coming from the respective entry and exit arrangement 9 can travel to all the travelways 8 of the respective storage level 6, and vice versa. In order to be able to configure the platforms 12 to be as small and space-saving as possible, there can be provision that, as will be explained further below with reference to FIGS. 36 and 37, the wheels 18 of the respective container transport vehicle 5 can be rotated through at least 90° about the respective vertical axis 36 with respect to the direction of rectilinear travel 14 by means of the steering system 16.

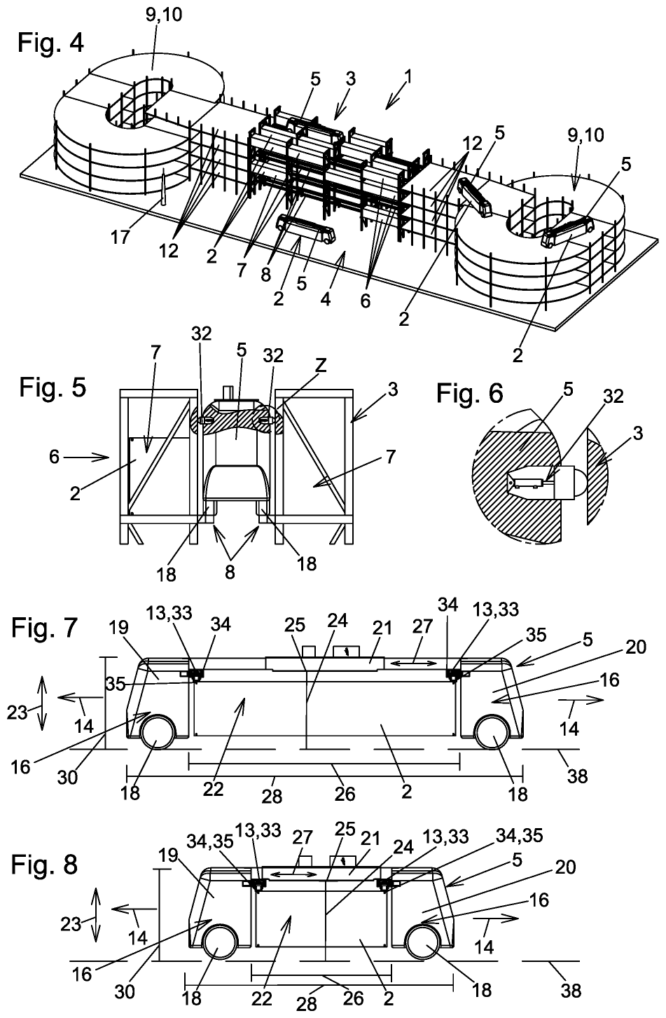

FIG. 4 now shows a variant in which the entry and exit arrangements 9 are not configured as an elevator 11 but in each case as a ramp 10. The container transport vehicles 5 can travel over these ramps 10 and the adjoining platforms 12 to the respective travelway 8 of the respective storage level 6 and, in the reverse direction, from the respective travelway 8 to the container-depositing surface 4, as is also illustrated in FIG. 4. In this exemplary embodiment, all the storage levels 6 and their travelways 8 can be reached via the ramps 10.

In all the embodiment variants of FIGS. 1 to 4, the rack compartments 7 in the respective storage levels 6 are arranged behind one another in rows along the respective travelways 8. The rack compartments 7 are situated laterally next to the respective travelway 8. It is particularly advantageous, as also illustrated here, if in each case rack compartments 7 for storage and retrieval of the containers 2 are situated on both sides of the respective travelway 8.

FIG. 5 shows in enlarged form a vertical section through the high-rack store 3 in the region of a travelway 8 in a storage level 6. There is illustrated a container transport vehicle 5 which is currently situated on the travelway 8 such that it can either store a container 2 into the empty rack compartment 7 situated next to it on the right or remove from there the container 2 already stored in the rack compartment 7 situated next to it on the left and transport it back to the container-depositing surface 4. As illustrated in FIG. 5, the travelway 8 can be designed very minimalistically. It ultimately only has to offer a sufficient supporting surface for the wheels 18 of the container transport vehicle 5. Of course, closed road-like travelways 8 are alternatively also possible. In FIG. 5, the container transport vehicle 5 is partially illustrated in section in the region of the lateral supports 32. FIG. 6 shows the region Z from FIG. 5 in enlarged form. It can be clearly seen there that preferred embodiments of the container transport vehicles 5 have retractable and extendable lateral supports 32 by means of which they can be supported on the high-rack store 3 during lateral loading and unloading of the containers 2. In FIGS. 5 and 6 and in the illustrations of the various container transport vehicles 5 still to be explained below, these lateral supports 32 are each realized as support props which can be retracted into and extended from the container transport vehicle 5. Of course, it would also be conceivable for corresponding lateral supports to be provided not in the container transport vehicle 5 but alternatively in the high-rack store 3 at the corresponding locations.

A description will be given below with reference to FIGS. 7 to 34 of a first exemplary embodiment of a container transport vehicle 5 which can be used in container terminals 1 according to the invention. FIGS. 7 and 8 show first of all a lateral view of the schematically illustrated container transport vehicle 5. The container transport vehicle 5 has wheels 18 and a steering system 16. By means of these wheels 18 and the steering system 16, it can travel on an underlying surface 38 both rectilinearly and around curves. It is thus freely steerable and not rail-bound or the like. The direction of rectilinear travel 14 is depicted in FIGS. 7, 8, 11, 13, 15, 19 and 21. The container transport vehicle 5 has a first vehicle part 19 with a first part of the wheels 18 and a second vehicle part 20 with a second part of the wheels 18. The first vehicle part 19 and the vehicle part 20 are connected to one another by means of a crossmember 21. Below the crossmember 21 and between the vehicle parts 19 and 20 is situated the container receiving space 22. In this first exemplary embodiment, the container transport vehicle 5 is configured to receive a single container 2. Further below, however, there are also described other exemplary embodiments in which an individual container transport vehicle 5 can simultaneously receive more than one container 2.

In order to receive the container 2, the container transport vehicle 5 has a loading and unloading device 13. This makes it possible for the container transport vehicle 5 to be able to load a container 2 and also to unload it again automatically and without further assistance. With respect to the direction of rectilinear travel 14, the first vehicle part 19 is arranged in front of the container receiving space 22 and the second vehicle part 20 is arranged behind the container receiving space 22. In this exemplary embodiment and also in other preferred variants, the container receiving space 22 is open toward both sides 15 in order to load and unload the at least one container 2.

The container transport vehicle 5 is, as also illustrated here, preferably of elongate design. This means that its length 28 is greater than its width 29 and its height 30. Here, the height 30 is measured in the vertical direction 23 from the lower edge of the wheels 18 to the maximum vertical extent of the container transport vehicle 5.

By contrast with straddle carriers known per se in the prior art, the container transport vehicle 5 is, as also realized here, advantageously designed to be as shallow as possible so that the storage levels 6 of the high-rack store 3 also need not be configured to be unnecessarily high. The distance 24, measured in the vertical direction 23, between the lower edge 25 of the crossmember 21 and the planar underlying surface 38 on which the container transport vehicle 5 stands with its wheels 18 is, as already explained at the outset, advantageously at most 3.30 m, preferably at most 2.90 m.

In principle, it is conceivable that the container transport vehicles 5 are designed with a fixed length 28 and thus also with a fixed length 26 of the container receiving space 22. They are then as a rule simply only suitable for receiving a container type of a certain length. In such cases, if containers 2 of different lengths are intended to be stored in and retrieved from the high-rack store 3, there can be provision that the container terminal 1 simply comprises a fleet of container transport vehicles 5 of different lengths.

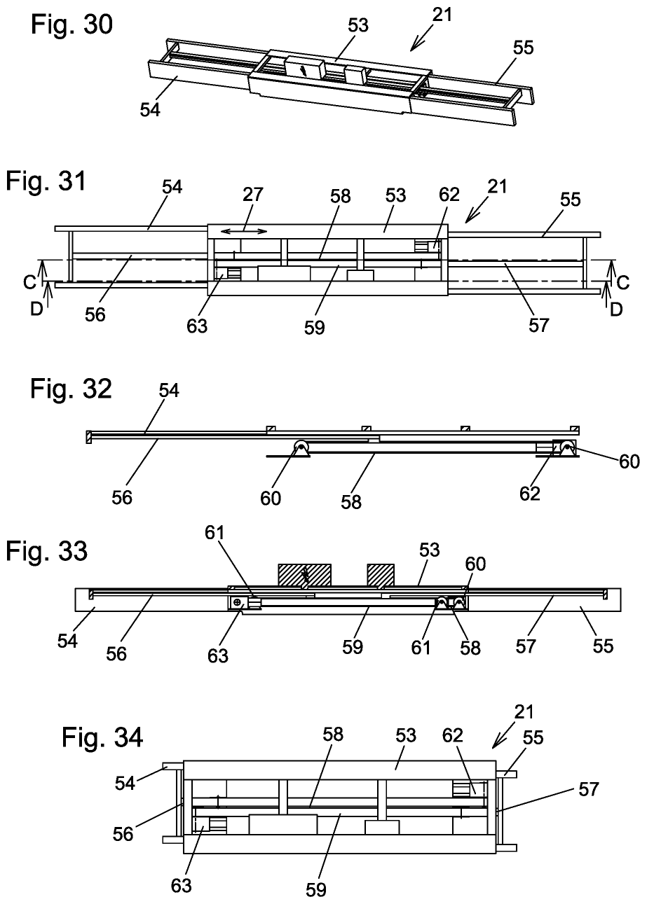

However, as also realized in the exemplary embodiment shown here, there is preferably provision that the container transport vehicles 5 can be adapted to container types of different lengths such that a single container transport vehicle 5 can receive containers 2 of different lengths, transport them and also deposit them again. For this purpose, preferred variants of the container transport vehicles 5, and also the variant shown in FIGS. 7 to 34, provide that, for adaptation of the length 26 of the container receiving space 22 to containers 2 of different lengths, the crossmember 21 is designed to be length-adjustable in the direction of longitudinal extent 27 of the crossmember 21. For this purpose, the crossmember 21 can be designed as a type of telescope such that the distance between the vehicle parts 19 and 20 and thus the length 26 of the container receiving space 22 can be adapted to various container types or lengths. In the first exemplary embodiment, FIGS. 7 and 8 show in this context the same container transport vehicle 5, wherein the length of the crossmember 21 and thus also the length 26 of the container receiving space 22 has been adapted to the respective length of the container 2. An example of how such a telescopically designed crossmember 21 can be configured is explained further below with reference to FIGS. 30 to 34. Of course, however, there are also other embodiments of how such a crossmember 21 can be designed to be telescopic for the length adjustment of the container transport vehicle 5.

The fact that the container transport vehicles 5 are preferably designed to be self-driving, although this is not absolutely necessary, has already been explained further above, as has their preferably wireless communication with the vehicle control center 17. This also applies to all the exemplary embodiments shown here.

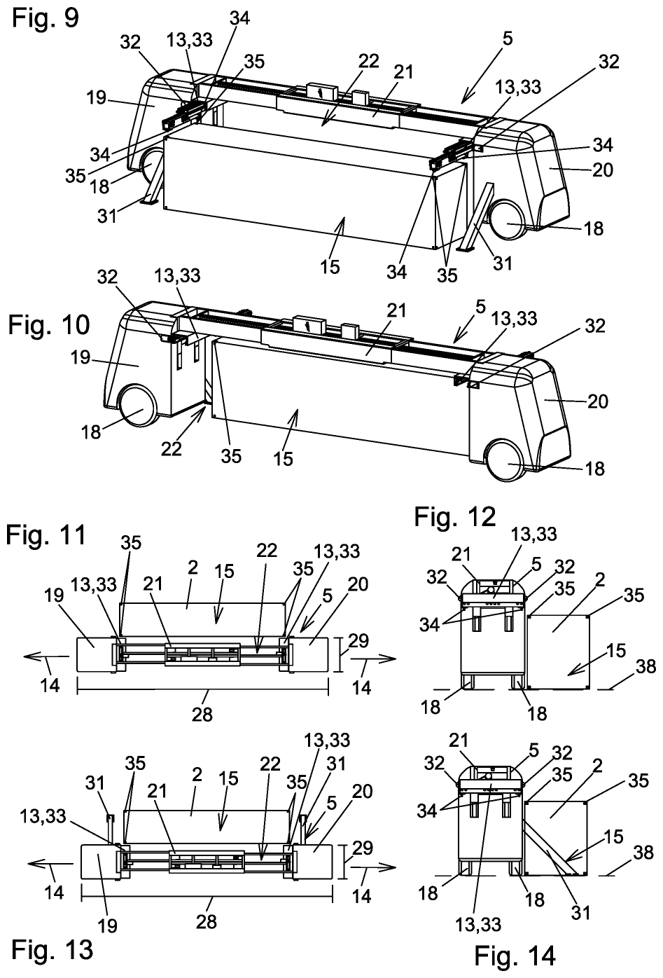

It is preferable, as also provided in this first exemplary embodiment of a container transport vehicle 5, that the loading and unloading device 13 of the vehicle is configured in such a way that, with respect to the direction of rectilinear travel 14, it is designed for loading at least one container 2 situated laterally next to the container transport vehicle 5 into the container receiving space 22 and correspondingly also for unloading the at least one container 2 from the container receiving space 22 onto one side 15. There is particularly preferably provision that the loading and unloading device 13 is configured in such a way that it allows loading and unloading of the containers 2 from and onto both sides 15 next to the container transport vehicle 5. This is illustrated by way of example in FIGS. 9 and 10. FIG. 9 shows how a container 2 can be loaded from one side 15 onto the container transport vehicle 5 or unloaded therefrom onto one side 15. FIG. 10 shows the same operation toward the other side 15.

To ensure that, during the loading and unloading operation, the container transport vehicle 5 can be supported toward the sides on the container-depositing surface 4, it preferably has lateral supports 31 for supporting the vehicle on the respective underlying surface 38. As known per se from trucks, for example, said supports can be extended before the loading or unloading operation and also retracted again after completion of the loading and unloading operation.

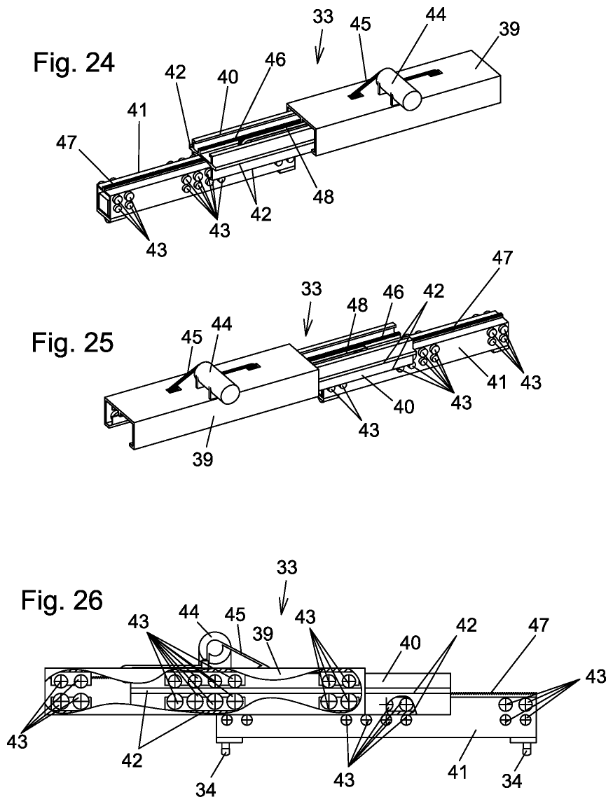

The loading and unloading device 13 of the container transport vehicle 5 of the first exemplary embodiment shown here comprises two container carrying elements 33 which can be retracted and extended laterally, in this exemplary embodiment on both sides, with respect to the direction of rectilinear travel 14 and which can be raised and lowered in the vertical direction 23. They could also be referred to as telescopic arms. Such telescopic arms, which are able to take up and also lift loads, are known per se in the prior art. However, the design and the mode of operation of the container carrying elements 33 used here will be explained further below by way of example with reference to FIGS. 24 to 29.

In this exemplary embodiment, two gripping elements 34 are situated on each of the container carrying elements 33 and allow a container 2 to be fastened to the respective container carrying element 33. In the exemplary embodiment shown here, the fastening of the gripping elements 34 to the container 2 occurs at the corner fittings 35 provided in this type of container 2. If the containers 2 are so-called ISO containers, the gripping elements 34 which can be used are twistlocks known per se. These fit into the corner fittings 35 of the ISO containers known per se. The mode of operation of the twistlocks is known per se, and therefore the gripping elements 34, which are realized here in this exemplary embodiment, need not be further explained.

The operation of loading a container transport vehicle 5 with a container 2, that is to say in other words the operation of loading a container 2 onto a container transport vehicle 5, will now be explained by way of example with reference to FIGS. 11 to 22. Here, the container 2 can be situated both on the container-depositing surface 4 and in a rack compartment 7. This makes no difference for the loading operation and also for the unloading operation, which is correspondingly carried out the other way around. FIGS. 11, 13, 15, 19 and 21 show various stages of the loading operation, in each case in a plan view. FIGS. 12, 14, 16, 17, 18, 20 and 22 each show schematic vertical sections through container 2 and container transport vehicle 5.

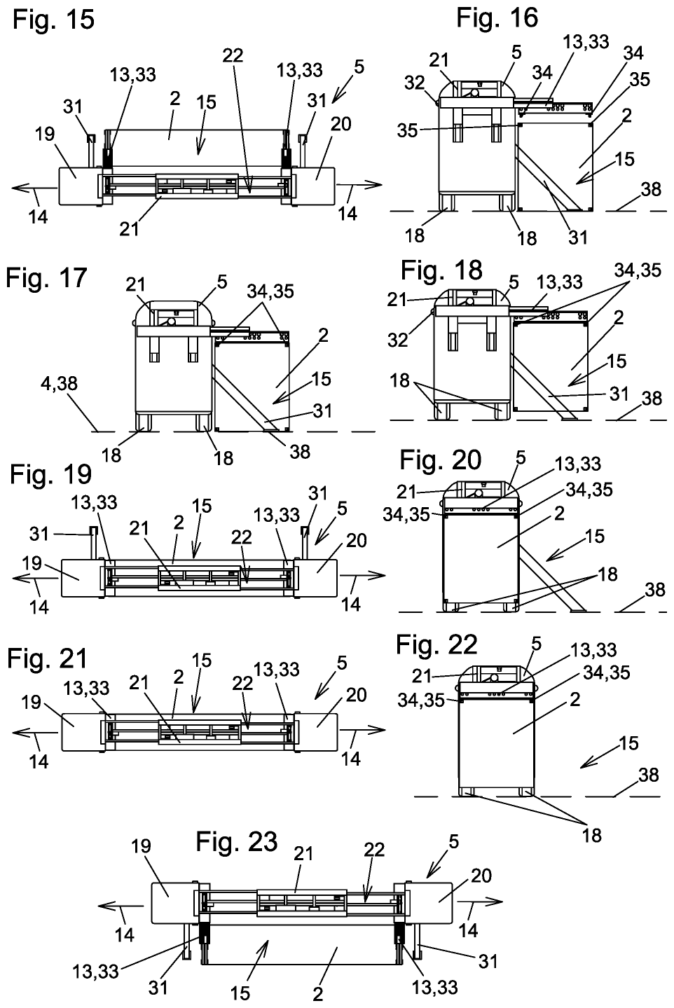

First of all, the container transport vehicle 5, as shown in FIGS. 11 and 12, drives next to the container 2 deposited on an underlying surface 38 such that said container is arranged on one side 15 next to the container receiving space 22 of the container transport vehicle 5. Then, as shown in FIGS. 13 and 14, the lateral supports 31 are retracted and supported on the underlying surface 38 on this side 15. Next, the container carrying elements 33 are extended onto this side 15 such that they are correspondingly arranged with the gripping elements 34 above the container 2 and its corner fittings 35. This is shown in FIGS. 15 and 16. The container carrying elements 33 are then lowered to such an extent that the gripping elements 34 can be fastened in the corner fittings 35 in a form-fitting manner. This is schematically illustrated in FIG. 17. Once the gripping elements 34 are correspondingly locked, the container 2 is lifted from the underlying surface 38 on the container carrying elements 33, as is shown in FIG. 18. The container 2 is then moved into the container receiving space 22 by retracting the container carrying elements 33; see FIGS. 19 and 20. Finally, the supports 31 are also retracted such that the loading operation, as illustrated in FIGS. 21 and 22, is then completed and the container transport vehicle 5 can move the loaded container 2 either to a rack compartment 7 in the high-rack store 3 or move it back from this rack compartment 7 to the container-depositing surface 4. This is where the unloading operation then occurs in the opposite order to the loading operation described, that is to say as it were starting from FIGS. 21 and 22 toward FIGS. 11 and 12. FIG. 23 once again shows a plan view like FIG. 15. It is intended to illustrate only once again here that in preferred container transport vehicles 5 it is actually provided that the containers 2 can be loaded and unloaded from both sides 15 laterally of the container transport vehicle 5.

It will now be explained by way of example below with reference to FIGS. 24 to 29 how the container carrying elements 33 of the container transport vehicle 5 can be embodied according to the first exemplary embodiment. However, as already stated, this is only one example. The prior art discloses in principle a wide variety of technologies as to how such telescopic container carrying elements 33 could be embodied. The drives for raising and lowering the container carrying elements in the vertical direction 23 are not depicted separately. They can be embodied in embodiments which are known per se.

FIGS. 24 and 25 show first of all that the respective container carrying element 33 can be extended both in one direction and in the other direction in order thereby to be able to receive containers 2 from both sides 15 next to the container transport vehicle 5 or to be able to deposit them there. The respective container carrying element 33 has an outer part 39, a central part 40 and an inner part 41 which are mounted telescopically inside one another. For this purpose, the central part 40 has guide rails 42. As can be seen in particular in the partially sectioned view according to FIG. 26, the outwardly projecting, clearly visible guide rails 42 are guided between guide rollers 43 mounted rotatably on the outer part 39. The inwardly projecting guide rails 42 of the central part 40, which can be seen actually only in FIG. 26 in the partially cut-away illustrations, are correspondingly guided between guide rollers 43 which are fastened rotatably on the inner part 41.

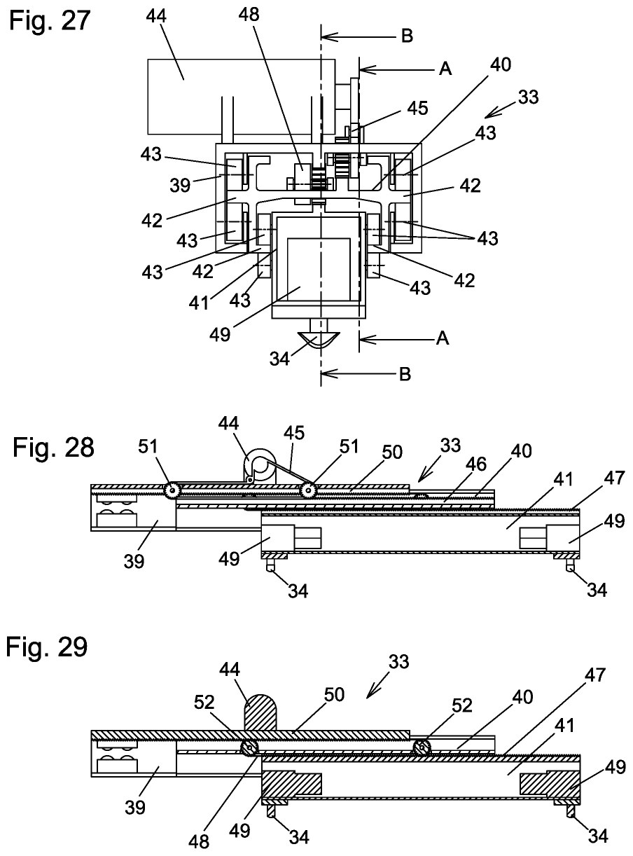

The here realized type of drive for retracting and extending the central part 40 and inner part 41 into and out of the outer part 39 is explained below with reference to FIGS. 27 to 29. FIG. 27 here shows a vertical section transversely with respect to the longitudinal extent through the container carrying element 33. FIG. 28 shows the longitudinal section, orthogonal thereto, along the section line AA. FIG. 29 shows the longitudinal section, parallel to AA, along the section line BB from FIG. 27. The drive realized here by way of example comprises the chain drive or chain drive motor 44 which drives, via a drive chain 45, the two toothed wheels 51 fixed rotatably on the outer part 39. These toothed wheels 51 engage in a rack 46 which is fixed on the central part 40. The central part 40 can thus be retracted into and extended out of the outer part 39 by rotating the toothed wheels 51 by means of the chain drive 44.

As can be seen in FIG. 29, two toothed wheels 52 are rotatably fastened to the central part 40 and are in turn positively coupled to one another by means of a transmission chain 48. By displacing the central part 40 relative to the outer part 39, always at least one of the toothed wheels 52 is rotated via the engagement in the rack 50 fixed on the outer part 39. This rotary movement is necessarily also transmitted to the other toothed wheel 52 via the transmission chain 48. At least one of the two toothed wheels 52 is in turn in engagement with the rack 47 which is formed on the inner part 41. This results in the fact that a relative displacement of the central part 40 relative to the outer part 39 necessarily also leads to a relative displacement of the inner part 41 relative to the central part 40 and thus also relative to the outer part 39. This results in the fact that the inner part 41 is always concomitantly extended or retracted relative to the central part 40 synchronously with the retraction or extension movement of the central part 40 into or out of the outer part 39. FIGS. 28 and 29 additionally also show the rotary drives 49 by means of which the gripping elements 34, configured here as twistlock, can be rotated about their vertical axis in order thereby to be able to lock the gripping elements 34 in the corner fittings 35 of the container 2 and to unlock them.

It will now be explained with reference to FIGS. 30 to 34 how the crossmember 21 of the container transport vehicle 5 can be configured to be telescopic in order to be able to adapt the length 28 of the container transport vehicle 5 or the length 26 of the container receiving space 22 to the respective container length. This, too, is only one example of how this can be embodied. Other telescopes known per se can also be used here as crossmember 21 where appropriate in a correspondingly adapted manner.

In the present example, the crossmember 21 has a central part 53 and two pullouts 54 and 55 mounted so as to be displaceable therein in the longitudinal direction of extent 27. Each of the pullouts 54 and 55 can be pushed into and pushed out of the central part 53. At the ends of the pullouts 54 and 55 that face away from the central part 53, the crossmember 21 is fastened to the first vehicle part 19 or to the second vehicle part 20. However, this is not illustrated in FIGS. 30 to 34.

FIG. 30 shows a perspective illustration of the crossmember 21 in the pulled-out state. FIG. 31 shows a corresponding plan view. FIG. 32 shows the section CC, and FIG. 33 shows the section DD through the crossmember 21. In this respect, the section lines are depicted in FIG. 31. FIG. 34 shows a plan view of the crossmember 21 in which the pullouts 54 and 55 are pushed virtually completely into the central part 53.

Two toothed belts 58 and 59 are guided via deflection rollers 60 and 61 on the central part 53. The toothed belt 58 runs over the rollers 60 which are mounted rotatably, but are fixed in their position on the central part 53. The other toothed belt 59 runs over the deflection rollers 61 which are likewise arranged rotatably, but fixed in their position, on the central part 53. One of the deflection rollers 60 is driven by means of the drive motor 62. One of the deflection rollers 61 is driven by means of the drive motor 63. As can be seen particularly clearly in FIG. 32, a transmission rod 56 is fixed by one of its ends on the toothed belt 58. The transmission rod 56 is connected by the other end to the pullout 54. By rotating the deflection rollers 60 by means of the drive motor 62, the toothed belt 58 runs over the deflection rollers 60. Here, the transmission rod 56 and hence also the pullout 54 fastened thereon are necessarily moved concomitantly, which leads to a retraction and extension movement of the pullout 54 relative to the central part 53.

The transmission rod 57 is fixed by its one end on the other pullout 55 and has its other end fastened to the toothed belt 59. By rotating the deflection rollers 61 by means of the drive motor 63, the pullout 55 is concomitantly guided in an analogous manner as the toothed belt 59 runs along. By corresponding actuation of the drive motors 62 and 63, the pullouts 54 and 55 are thus retracted into the central part 53 and also extended again therefrom.

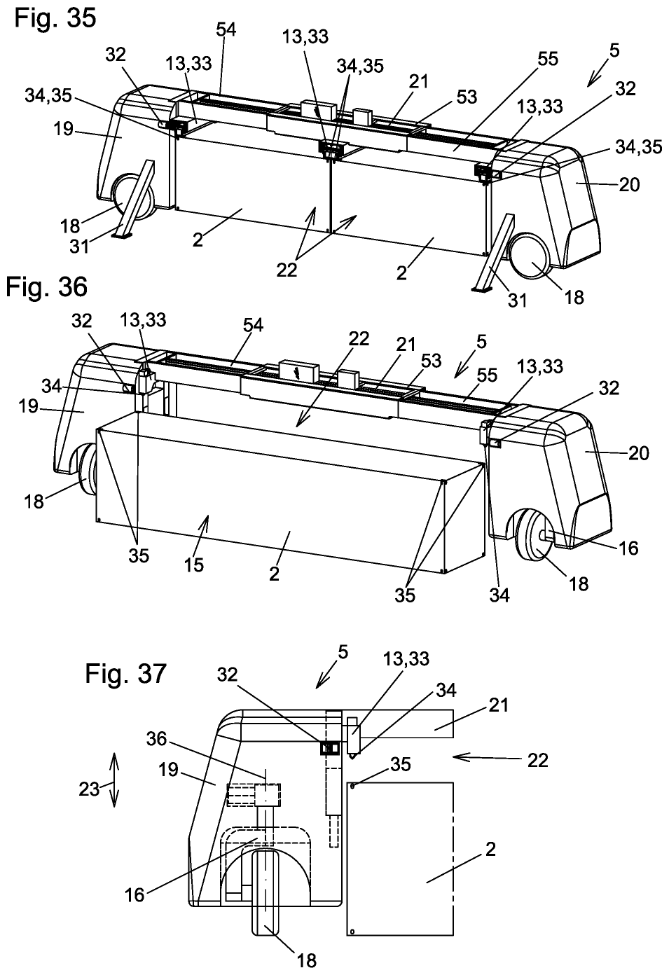

FIG. 35 shows a variant of a container transport vehicle 5, based on the above-described embodiment according to FIGS. 7 to 34. The key difference is that, in the variant according to FIG. 35, the loading and unloading device 13 and also the container receiving space 22 of the container transport vehicle 5 are configured in such a way that, as illustrated in FIG. 35, the container transport vehicle 5 can also simultaneously receive and transport two containers 2. For this purpose, the central part 53 of the crossmember 21 has arranged thereon additional container carrying elements 33 which can otherwise be formed like the container carrying elements 33 already described above and also arranged here on the outer edges of the container receiving space 22. This makes it possible, as illustrated in FIG. 35, for two containers 35, arranged behind one another in their longitudinal direction, to be simultaneously received in the container receiving space 22. Here, too, the length adjustability of the crossmember 21 allows corresponding adaptation to the length of the containers.

In addition, there can also be provision that the container carrying elements 33 on the central part 53 of the crossmember 21 can be raised to such an extent that, as a departure from the illustrations shown, a single, continuous container 2 can also be received in the container receiving space 22 without colliding with the central container carrying elements 33 on the central part 53 of the crossmember 21. Otherwise, what has been stated further above in relation to the first exemplary embodiment of the container transport vehicle 5 applies to this exemplary embodiment according to FIG. 35.

FIGS. 36 and 37 show a further variant of a container transport vehicle 5 which is configured in principle like the first exemplary embodiment according to FIGS. 7 to 34. However, unlike this first exemplary embodiment, in this variant according to FIGS. 36 and 37 the wheels 18 of the container transport vehicle 5 can be rotated through at least 90° about the respective vertical axis 36 with respect to the direction of rectilinear travel 14 by means of the steering system 16. In preferred embodiments, this applies to all wheels 18 of the container transport vehicle 5 and allows the container transport vehicle 5 also to be able to travel in a direction orthogonal to the direction of rectilinear travel 14.

This steerability through at least 90° allows the process of loading and unloading the container 2 to be changed by comparison with the above-described exemplary embodiments of the container transport vehicle 5. It becomes possible by means of this type of steering system 16 that the container transport vehicle 5 according to FIGS. 36 and 37 first of all drives next to the container 2 deposited on an underlying surface 38 and then turns the wheels 18 in a direction orthogonal to the direction of rectilinear travel 14 and thus moves over the container 2 such that the latter is then arranged in the container receiving space 22. In these variants of container transport vehicles 5, the container carrying elements 33 then also need not necessarily be configured to be telescopic. It is sufficient if they can be raised and lowered in the vertical direction 23. In the lowered state, the gripping elements 34 can then be locked in the corner fittings 35 of the container 2 and the container can then be raised in the container receiving space 22 in such a way that the container transport vehicle 5 can then transport the container 2 to the container-depositing surface 4 or to one of the rack compartments 7 depending on the requirement. The unloading operation then occurs in particular on the container-depositing surface 4 in a corresponding manner in that the container 2 is first of all deposited on the underlying surface 38 by lowering the container carrying elements 33 and then, after unlocking the gripping elements 34 and subsequently raising the container carrying elements 33, the container transport vehicle 5 moves away to the side from the container 2 standing on the underlying surface 38.

This loading and unloading operation with the variant according to FIGS. 36 and 37 can thus be practiced in principle both on the container-depositing surface 4 and in the rack compartments 7 of the high-rack store 3. For this purpose, there must be present in the rack compartments 7 only corresponding additional travelways oriented in the orthogonal direction with respect to the respective travelway 8 and a corresponding amount of space for the vehicle parts 19 and 20. If it is desired to save on this in the embodiment of the high-rack store 3, the container carrying elements 33 can also be configured to be telescopic exactly as in the first exemplary embodiment of the container transport vehicle 5 according to FIGS. 7 to 34, with the result that the unloading of a container 2 into a rack compartment 7 and also the removal of a container 2 from the rack compartment 7 in the high-rack store 3 can then occur as in the first exemplary embodiment.

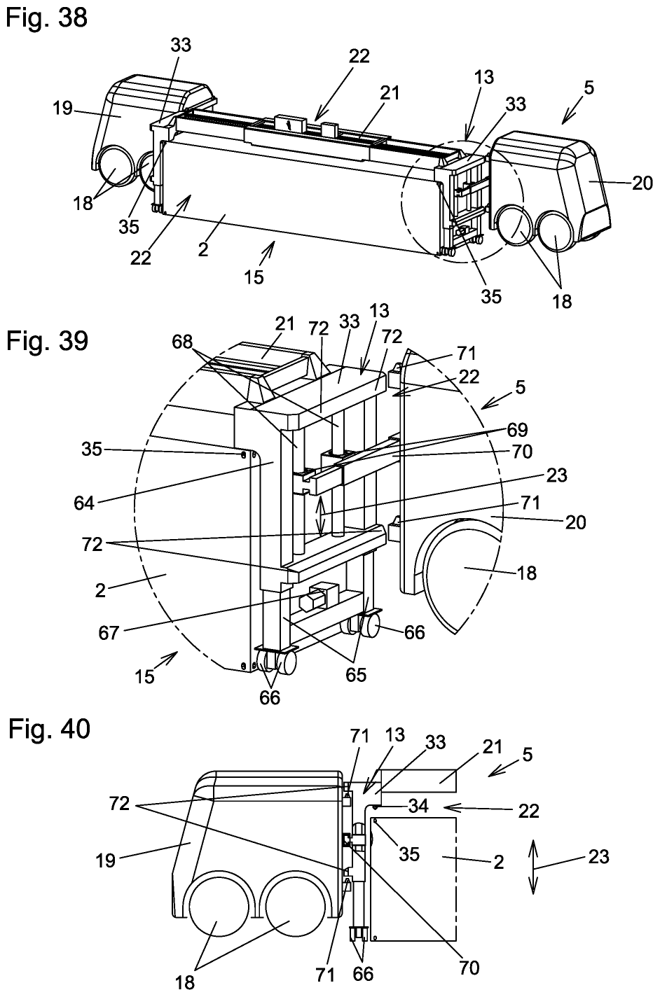

FIGS. 38 to 47 now illustrate a further embodiment of a container transport vehicle 5. Here, too, the crossmember 21 is advantageously configured to be length-adjustable in order to be able to perform a corresponding adaptation to different container lengths. However, other than in the previous exemplary embodiments, in such variants, as are shown in FIGS. 38 to 47, there is provision that the loading and unloading device 13 of the container transport vehicle 5 forms, with the crossmember 21, a frame-shaped structure which can be extended toward the side 15 in order to thus load or unload a container 2. Specifically, there is advantageously provision in such embodiments that the container carrying elements 33 are connected to one another by means of the crossmember 21 and each have an upper part 64 and a lower part 65, wherein rollers 66 which are driven by means of a roller drive 67 are arranged on the lower part 65. Preferably, the frame-shaped structure consisting of the two container carrying elements 33 and the crossmember 21 can then be retracted and extended toward the side 15 on the rollers 66 by means of the roller drive 67 for loading and unloading the container 2. Each container carrying element 33 is advantageously, as also realized here, mounted so as to be displaceable on one of the vehicle parts 19 and 20 by means of a horizontal sliding guide 70. Arranged in turn on the sliding guide 70 are guide bushes 69 which are mounted so as to be displaceable in the vertical direction 23 on columns 68 of the upper part 64 of the respective container carrying element 33. The columns 68 are anchored fixedly in the upper part 64. The upper part 64 and the lower part 65 are mounted telescopically inside one another in the vertical direction 23. A drive, which is not illustrated here but is advantageously arranged inside the upper part 64 and the lower part 65, ensures that the respective upper part 64 and the respective lower part 65 of a container carrying element 33 are displaceable relative to one another in the vertical direction 23. This drive (not shown here) for vertically adjusting the upper part 64 and lower part 65 can be configured as known per se in the prior art. It can be hydraulic or pneumatic cylinders, spindle drives or other suitable linear drives.

Additionally provided on the upper parts 64 are stud receptacles 72 by means of which the upper parts 64 of the respective container carrying elements 33 can each be hooked into corresponding studs 71 on the respective vehicle part 19 or 20.

The length adjustability or length telescopeability of the crossmember 21 and also the mode of operation and embodiment of the gripping elements 34 can be realized as for the embodiments already described above.

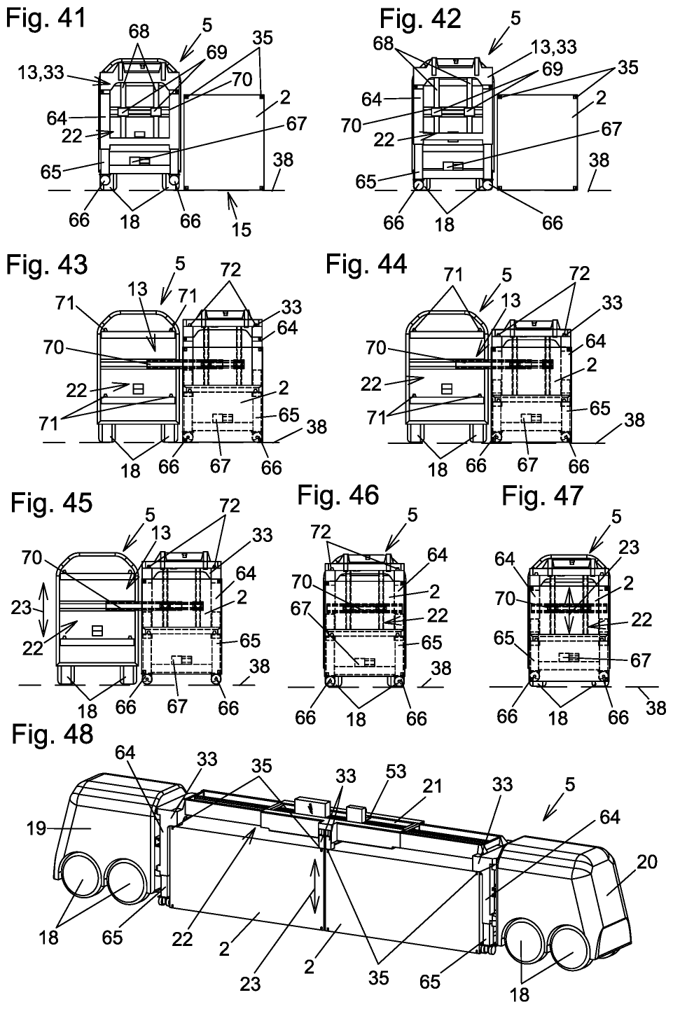

The operation of loading a container 2 onto this container transport vehicle 5 according to FIGS. 39 to 47 will now be explained by way of example with reference to FIGS. 41 to 47. The unloading operation occurs in a correspondingly reversed order, without this then having to be described explicitly. Here, in this exemplary embodiment, corresponding loading and unloading of containers 2 is again possible both at the container-depositing surface 4 and at the rack compartments 7 in the high-rack store 3. Additional travelways for the rollers 66 in a direction orthogonal to the respective travelway 8 must then be correspondingly provided in the rack compartments 7.

FIG. 41 first of all shows how the container transport vehicle 5 has driven next to the container 2 such that the container 2 is arranged laterally next to the container receiving space 22 of the container transport vehicle 5. As visible in FIG. 41, the rollers 66 of the lower parts 65 of the container carrying elements 33 are still here raised above the underlying surface 38. In this state, the container carrying elements 33 are hooked with their stud receptacles 42 on the studs 41 and thus on the vehicle parts 19 and 20.

During the loading operation, according to FIG. 42, first of all the lower part 65 is lowered and then, as soon as the rollers 66 stand on the underlying surface 38, the upper part 64 is raised in the vertical direction 23 to such an extent that the studs 71 are moved out of the stud receptacles 72. Then, as shown in FIG. 43, the container carrying elements 33 including the crossmember 21 can be moved toward the side by means of the roller drives 67 and the rollers 66 such that the container 2 is then arranged between the container carrying elements 33 and the crossmember 21. Subsequently, as illustrated in FIG. 44, the upper part 64 is then lowered to such an extent that the gripping elements 34 of the container carrying elements 33 can be moved into the respective upper corner fittings 35 of the container 2 and locked in a form-fitting manner there. During this lowering of the upper part 64, the columns 68 are displaced to a corresponding extent in the vertical direction 23 in the guide bushes 69. After locking of the gripping elements 34 has occurred, the upper parts 64 together with the crossmember 21 and the container 2 now locked on the gripping elements 34 are raised in the vertical direction 23 such that the container 2 is lifted from the underlying surface 38, as is illustrated in FIG. 45. This occurs by means of the drives, which allow a relative displacement between the upper part 64 and lower part 65 in the vertical direction 23. The frame-shaped structure consisting of the container carrying elements 33 and the crossmember 21 together with the container 2 suspended thereon is then moved by means of the rollers 66 and the roller drive 67 into the container receiving space 22 between the first and the second vehicle part 19 and 20 to such an extent that the stud receptacles 72 come to lie again above the studs 71 of the vehicle parts 19 and 20; see FIG. 46. The upper part 64 is then in turn lowered in the vertical direction 23 to such an extent that the stud receptacles 72 come to lie on the studs 71. The lower parts 65 are then raised to such an extent that the rollers 66 are lifted from the underlying surface 38. The frame-shaped structure consisting of the container carrying elements 33 and the crossmember 21 is then suspended together with the container 2 on the vehicle parts 19 and 20, as is illustrated in FIG. 47. Once this state is reached, the loading operation is concluded and the container transport vehicle 5 can transport the container 2 to the desired location on the container-depositing surface 4 or to the desired rack compartment 7 in the high-rack store 3. The following unloading operation then occurs, as already stated, in the reverse order to the loading operation, without this having to be further explained.

FIG. 48 shows a modified form of a container transport vehicle 5, based on the variant according to FIGS. 39 to 47. Here, the key difference is that the container transport vehicle 5 according to FIG. 48 is again designed such that not only one container 2 but two containers 2 arranged behind one another in the longitudinal direction can be simultaneously received in the container receiving space 22 and transported. For this purpose, additional container carrying elements 33 having corresponding gripping elements 34 are again provided on the central part 53 of the crossmember 21. These additional container carrying elements 33 can be rigidly arranged on the central part 53 of the crossmember 21. However, preferred embodiments provide that these additional carrying elements 33 are configured such that they can be moved in the vertical direction 23 with respect to the central part 53 of the crossmember 21. This allows the container carrying elements 33 to also be moved upward to such an extent that a single container 2 fastened on the outer container carrying elements 33 can be arranged in the container receiving space 22.

In the case of container transport vehicles 5 as are shown in FIGS. 38 to 48, it is also possible to dispense with the lateral supports 31 and 32.

### KEY FOR THE REFERENCE NUMBERS

| | |
|---|---|
| 1 | Container terminal |
| 2 | Container |
| 3 | High-rack store |
| 4 | Container-depositing surface |
| 5 | Container transport vehicle |
| 6 | Storage level |
| 7 | Rack compartment |
| 8 | Travelway |
| 9 | Entry and exit arrangement |
| 10 | Ramp |
| 11 | Elevator |
| 12 | Platform |
| 13 | Loading and unloading device |
| 14 | Direction of rectilinear travel |
| 15 | Side |
| 16 | Steering system |
| 17 | Vehicle control center |
| 18 | Wheel |
| 19 | First vehicle part |
| 20 | Second vehicle part |
| 21 | Crossmember |
| 22 | Container receiving space |
| 23 | Vertical direction |
| 24 | Distance |
| 25 | Lower edge |
| 26 | Length |
| 27 | Direction of longitudinal extent |
| 28 | Length |
| 29 | Width |
| 30 | Height |
| 31 | Lateral support |
| 32 | Lateral support |
| 33 | Container carrying element |
| 34 | Gripping element |
| 35 | Corner fitting |
| 36 | Vertical axis |
| 37 | Outer envelope |
| 38 | Underlying surface |
| 39 | Outer part |
| 40 | Central part |
| 41 | Inner part |
| 42 | Guide rail |
| 43 | Guide roller |
| 44 | Chain drive |
| 45 | Drive chain |
| 46 | Rack |
| 47 | Rack |
| 48 | Transmission chain |
| 49 | Rotary drive |
| 50 | Rack |
| 51 | Toothed wheel |
| 52 | Toothed wheel |
| 53 | Central part |
| 54 | Pullout |
| 55 | Pullout |
| 56 | Transmission rod |
| 57 | Transmission rod |
| 58 | Toothed belt |
| 59 | Toothed belt |
| 60 | Deflection roller |
| 61 | Deflection roller |
| 62 | Drive motor |
| 63 | Drive motor |
| 64 | Upper part |
| 65 | Lower part |
| 66 | Roller |
| 67 | Roller drive |
| 68 | Column |
| 69 | Guide bush |
| 70 | Sliding guide |
| 71 | Stud |
| 72 | Stud receptacle |

1. A container terminal for handling containers, the container terminal comprising:
at least one high-rack store;
at least one container-depositing surface arranged outside the high-rack store;
a multiplicity of container transport vehicles for transporting the containers;
the high-rack store has a plurality of storage levels arranged above one another and, in each said storage level, a plurality of rack compartments configured to receive at least one of the containers;
each said storage level has, between the rack compartments, at least one travel way over which the container transport vehicles travel; and
at least one entry and exit arrangement which connects the container-depositing surface to the travelways in the storage levels and over which the container transport vehicles are adapted to travel.

2. The container terminal as claimed in claim 1, wherein the entry and exit arrangement comprises at least one of a ramp over which the container transport vehicles are adapted to travel or an elevator for the container transport vehicles.

3. The container terminal as claimed in claim 1, wherein at least some of the rack compartments in the respective storage level are arranged behind one another in a row along the travelway of said storage level.

4. The container terminal as claimed in claim 1, wherein at least one of the storage levels has two of the travelways, and between said travelways and the entry and exit arrangement there is arranged a drive-over platform for the travel of the container transport vehicles at least one of from the entry and exit arrangement to the travelways of said storage level from the travelways of said storage level to the entry and exit arrangement.

5. The container terminal as claimed in claim 1, wherein the container transport vehicles each have a loading and unloading device for loading at least one of the containers onto the container transport vehicle and for unloading the at least one of the containers from the container transport vehicle.

6. The container terminal as claimed in claim 5, wherein the container transport vehicles each have a direction of rectilinear travel and, with respect to the direction of rectilinear travel, the loading and unloading device of the respective container transport vehicle is configured for loading the at least one of the containers situated laterally next to the container transport vehicle onto the container transport vehicle and for unloading the at least one of the containers from the container transport vehicle onto one side next to the container transport vehicle.

7. The container terminal as claimed in claim 1, wherein the container transport vehicles each have a dedicated steering system.

8. The container terminal as claimed in claim 1, wherein the container transport vehicles are self-driving.

9. A method for operating a container terminal as claimed in claim 1, the method comprising:
for storing in one of the rack compartments, collecting the respective container by the container transport vehicle on the container-depositing surface and moving the respective container by the container transport vehicle via the entry and exit arrangement and the respective travelway of the respective storage level to next to the rack compartment and then storing the respective container in the rack compartment.

10. The method as claimed in claim 9, wherein the respective container is loaded onto the container transport vehicle and unloaded from the container transport vehicle by a loading and unloading device of the container transport vehicle.

11. The method of claim 9, further comprising:
for retrieving from one of the rack compartments, collecting the respective container by the container transport vehicle at the respective rack compartment and moving the respective container by the container transport vehicle via the respective travelway of the respective storage level and the entry and exit arrangement to the container-depositing surface, and unloading the respective container from the container transport vehicle at the container-depositing surface.

12. The container terminal as claimed in claim 1, wherein, in the respective storage level, the rack compartments are arranged laterally next to the travelway of said storage level.

13. The container terminal as claimed in claim 4, wherein the two travelways are arranged spaced apart from one another and extend parallel to one another on said storage level.

14. The container terminal as claimed in claim 1, further comprising a vehicle control center from which the container transport vehicles are wirelessly remote-controlled.
